(19) United States
(12) Patent Application Publication
(10) Pub. No.: US 2006/0008021 A1
(43) Pub. Date: Jan. 12, 2006

(54) Reduction of self-interference for a high symbol rate non-orthogonal matrix modulation

(75) Inventor: Jerome Bonnet, Munich (DE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/883,025

(22) Filed: Jun. 30, 2004

(51) Int. Cl. H04B 7/02

(52) U.S. Cl. 375/267

(57) ABSTRACT

A method for reducing self-interference between at least four data symbols that are modulated via a non-orthogonal matrix modulation and transmitted from at least four transmit antennas to at least one receive antenna comprises mapping the at least four data symbols onto the at least four transmit antennas and two orthogonal transmission resources via the non-orthogonal matrix modulation, multiplying data symbols mapped to one of the at least four transmit antennas with a factor γ, wherein γ is determined at least in dependence on the transmission channel characteristics from the at least four transmit antennas to the at least one receive antenna to reduce a self-interference between the at least four data symbols, and transmitting the mapped data symbols and the mapped and multiplied data symbols from the at least four transmit antennas to at least one receive antenna in the two orthogonal transmission resources.

### FIELD OF THE INVENTION

This invention relates to a method for reducing self-interference between at least four data symbols that are modulated via a non-orthogonal matrix modulation and transmitted from at least four transmit antennas to at least one receive antenna.

### BACKGROUND OF THE INVENTION

Conveying information over a multiple input multiple output (MIMO) system with multiple antennas at both the transmitter and receiver site of the transmission channel benefits from a significant enhancement of the channel capacity. This crucial fact has motivated a wide area of research over the past decade in order to better exploit multi-antenna systems.

However, the existence of various transmission sub-channels due to the spatial diversity used at the transmitter and/or at the receiver site has a harmful outcome, namely the interference caused by the simultaneous transmission of different signals between the receiver and the transmitter. In the remainder of this specification, this property will be called self-interference and should not be confused with the interference induced by the presence of multiple users in the same cell of a radio communication system for example.

Recently, space-time block codes have been designed to render this drawback less significant with the help of transmit diversity. This aim has been achieved with orthogonal linear space-time block codes such as the Alamouti block code (denoted as Space-Time Transmit Diversity STTD in the following), which gets rid of this self-interference by utilizing the temporal space in order to cancel the effect of the MIMO interference.

The STTD space-time block code can be considered as a matrix modulation scheme, which may be defined as a mapping of data symbols onto non-orthogonal spatial resources and orthogonal transmission resources, as for instance data symbol periods (i.e. time slots of the transmission channel), frequency carriers, codes, polarizations, eigenmodes of a channel, etc., or any combination of these.

In matrix modulation schemes, diversity may be applied. For instance, in a space-time matrix modulation scheme, at least one of said data symbols may be mapped to a first antenna in a first data symbol period and to a second antenna in a second data symbol period. Similarly, in a space-frequency matrix modulation scheme, at least one of said data symbols may be mapped to a first antenna and transmitted with a first carrier frequency and to a second antenna and transmitted with a second carrier frequency.

In the following part of this introduction, space-time matrix modulation methods (such as the orthogonal STTD block code) will be considered as an example of orthogonal and non-orthogonal matrix modulation methods. The orthogonal transmission resource is then represented by the T data symbol periods to which a block of N data symbols is mapped. However, the presented matrix modulation methods are readily applicable to matrix modulation that employs the frequency domain, the code domain, the eigenmode domain or polarization domain as orthogonal resource instead of the time domain.

A space-time matrix modulator employing Nt transmit antennas and T symbol periods is defined by a Nₜ×T modulation matrix X. The modulation matrix X is a linear function of the N complex-valued data symbols xₙ, n=1, . . . , N to be transmitted by the Nₜ-antenna transmitter during T data symbol periods. Data symbols may for instance obey the Binary Phase Shift Keying (BPSK), Quaternary Phase Shift Keying (QPSK) or Quadrature Amplitude Modulation (QAM) symbol alphabet. The modulation matrix X thus basically defines when data symbols xₙ with n=1, . . . , N and/or rotations thereof such as −xₙ, xₙ* or −xₙ* are transmitted from which transmit antenna nₜ=1, . . . , Nₜ at which time instance t=1, . . . , T. In this context, the superscript operator “*” denotes the conjugate-complex of a complex number. The matrix modulation then can be understood as a mapping (possibly including a rotation) of data symbols to Nₜ respective data streams that are transmitted by Nₜ respective transmit antennas during T data symbol periods, or, in a block-wise description, as a mapping (possibly including a rotation) of N data symbols to Nₜ transmit antennas and T data symbol periods. For the STTD space-time block code, the modulation matrix X_{STTD} is defined with T=2 and Nₜ=2 as

$${X}_{STTD} = [ \begin{matrix}{x}_{1} & - {x}_{2}^{*} \\ {x}_{2} & {x}_{1}^{*}\end{matrix} ] , \qquad ( 1 )$$

i.e. N=2 data symbols are matrix modulated for transmission in T=2 data symbols periods from Nₜ=2 transmit antennas.

With the modulation matrix X, a signal model for the application of orthogonal linear space-time block codes can be introduced. Let us denote by H the Nᵣ×Nₜ complex-valued channel matrix for a MIMO channel with Nₜ transmit antennas and Nᵣ receive antennas. The elements hᵢⱼ of H represent the flat-fading channel coefficients (or the channel impulse response) from transmit antenna j to receive antenna i, respectively. For instance, in a Rayleigh flat-fading channel, the coefficients hᵢⱼ of H are independent and identically distributed zero-mean complex Gaussian random variables with unit variance.

The signal model then can be written as
Y=H·X+noise, (2)
where Y is the Nᵣ×T matrix of received signals, the modulation matrix X with dimension Nₜ×T contains the matrix-modulated data symbols that are mapped to the Nₜ transmit antennas and T data symbol periods, and noise refers to the Nᵣ×T additive noise term, for instance white Gaussian noise with unit variance and zero-mean.

A more convenient signal model exists for linear space-time modulators and has the form
y=G·x+noise, (3)
wherein the successive rows of Y are stacked into the single vector y and symbols corresponding to even data symbol periods are complex conjugated. x contains the N distinct data symbols embedded into X, and G is the TNᵣ×N equivalent channel matrix. The structure of the latter depends on X and varies from one space-time block code to another.

Applying this equivalent signal model to the STTD block code and assuming Nᵣ=1 yields
y=G_{STTD}·x+noise, (4)
where

$${G}_{STTD} = [ \begin{matrix}{h}_{11} & {h}_{12} \\ {h}_{12}^{*} & - {h}_{11}^{*}\end{matrix} ] . \qquad ( 5 )$$

The self-interference induced by a linear space-time block code is visible in the off-diagonal coefficients of the matched filter matrix (or equivalent channel correlation matrix)
R=G^{H}·G, (6)
which in case of STTD takes the shape

$${R}_{STTD} = [ \begin{matrix}p & 0 \\ 0 & p\end{matrix} ] , \qquad ( 7 )$$

with
p=|h₁₁|²+|h₁₂|², if Nₓ=1,
and otherwise

$$p = {\sum }_{i = 1}^{{N}_{r}} {\vert {h}_{i , 1} \vert}^{2} + {\vert {h}_{i , 2} \vert}^{2} , if {N}_{r} > 1. \qquad ( 8 )$$

It is readily seen that, with all elements on the off-diagonals being zero, there is no self-interference between the N=2 data symbols, thus the STTD block code represents an orthogonal matrix modulation scheme.

The STTD block code has the desirable feature that no self-interference is caused, but the symbol rate of the STTD block code, which is defined as N/T (i.e. the number of data symbols transmitted per data symbol period, wherein a data symbol period corresponds to a time slot of the transmission channel), equals one (symbol-rate-1 matrix modulation scheme). It is a proven fact that the limitation to said symbol rate equaling 1 is a common feature of all orthogonal matrix modulation schemes.

To increase said symbol rate, which is directly proportional to the bit rate of a system that uses the matrix modulation method, it is possible to deploy non-orthogonal matrix modulation schemes, which are for instance obtained by combining two orthogonal matrix modulation schemes (as for instance two STTD block codes).

A symbol-rate-2 non-orthogonal matrix modulation scheme is the so-called Double STTD (DSTTD) block code with modulation matrix

$${X}_{DSTTD} = [ \begin{matrix}{X}_{STTD} ( {x}_{1} , {x}_{2} ) \\ {X}_{STTD} ( {x}_{3} , {x}_{4} )\end{matrix} ] = [ \begin{matrix}{x}_{1} & - {x}_{2}^{*} \\ {x}_{2} & {x}_{1}^{*} \\ {x}_{3} & - {x}_{4}^{*} \\ {x}_{4} & {x}_{3}^{*}\end{matrix} ] \qquad ( 9 )$$

i.e. , N=4 data symbols are mapped to T=2 data symbol periods and Nₜ=4 transmit antennas.

In the non-orthogonal DSTTD matrix modulation scheme, self-interference between the four data symbols arises due to non-zero elements as off-diagonal coefficients of the matched filter matrix RDSTTD. This self-interference can be considered as the price to be paid for the increase of the symbol rate of the matrix modulation scheme from 1 to 2, because now N=4 data symbols are transmitted from the Nₜ=4 transmit antennas in T=2 data symbol periods. A reduction of this self-interference could improve noticeably the overall performance of the transmission chain because any form of interference has a direct impact on the Bit Error Rate (BER) of a wireless communication system.

Another example of a non-orthogonal matrix modulation scheme, disclosed in International patent application WO 01/78294 A1, is the so-called “ABBA” space-time block code, which maps N=4 data symbols to T=4 data symbol periods and Nₜ=4 transmit antennas and thus is only a symbol-rate-1 matrix modulation scheme. However, as disclosed in WO 01/78294 A1, by using the ABBA matrix modulation scheme with three virtual (and two physical) transmit antennas and by multiplying the signals transmitted from the two transmit antennas with weight factors that depend on the transmission channel coefficients, a minimization of the self-interference terms on the off-diagonals of the ABBA matched filter matrix R_{ABBA} can be achieved.

However, even when self-interference is minimized, the ABBA matrix modulation scheme remains a symbol-rate-1 matrix modulation scheme, so that, in comparison to the symbol-rate-1 STTD matrix modulation scheme, no increase in bit rate is achieved.

### SUMMARY OF THE INVENTION

In view of the above-mentioned problems, it is now invented according to an embodiment of the present invention a method, a computer program, a computer program product, a system, a transmitter, a receiver and a module for reducing self-interference between data symbols that are modulated via a non-orthogonal matrix modulation with a symbol rate larger than 1.

A method is proposed for reducing self-interference between at least four data symbols that are modulated via a non-orthogonal matrix modulation and transmitted from at least four transmit antennas to at least one receive antenna, said method comprising mapping said at least four data symbols onto said at least four transmit antennas and two orthogonal transmission resources via said non-orthogonal matrix modulation, multiplying data symbols mapped to one of said at least four transmit antennas with a factor γ, wherein said factor γ is determined at least in dependence on the transmission channel characteristics from said at least four transmit antennas to said at least one receive antenna to reduce a self-interference between said at least four data symbols, and transmitting said mapped data symbols and said mapped and multiplied data symbols from said at least four transmit antennas to at least one receive antenna in said two orthogonal transmission resources.

Said at least four data symbols may for instance be phase- and/or amplitude modulated symbols of a limited symbol alphabet, as for instance BPSK, QPSK, 8-PSK, 16-PSK or QAM symbols. Said data symbols may stem from a stream of possibly source- and/or channel-encoded and/or interleaved data symbols and may be matrix modulated in blocks with a size of at least four data symbols.

Said non-orthogonal matrix modulation, which is defined by a modulation matrix, maps said at least four data symbols onto said at least four transmit antennas and two orthogonal transmission resources. Said orthogonal transmission resources may for instance be data symbol periods (or time slots), frequency channels, codes, polarizations or eigenmodes of a transmission channel. Said mapping may be understood as an assignment of said at least four data symbols and rotations thereof to said at least four transmit antennas and said two orthogonal transmission resources. For instance, a first data symbol of said at least four data symbols may be assigned to the first transmit antenna and the first orthogonal resource, and a rotation of said first data symbol may be assigned to the first transmit antenna and the second orthogonal resource, and similar for the at least three further data symbols.

Said matrix modulation, which may for instance be represented by a linear block code, is non-orthogonal, so that self-interference arises between at least two of the at least four data symbols. Said non-orthogonality of said matrix modulation is indicated by non-zero elements on the off-diagonals of the matched filter matrix (equivalent channel correlation matrix) that is defined by said matrix modulation. Said non-orthogonal matrix modulation may for instance be represented by an DSTTD block code.

Said at least four transmit antennas may be associated with a transmitter, and said at least one receive antenna may be associated with a receiver in a communication system, which may be a wireless or wire-bound communication system. In the latter case, the antennas are understood as interfaces between said transmitter and the transmission medium, for instance a cable or optical fiber. Each antenna may equally well be composed of a plurality of sub-antenna elements, such as sectorized or omnidirectional antennas, or be represented by an antenna array that performs beamforming. Said transmitter may equally well comprise more that four antennas. Said transmit antennas may equally well be understood as virtual transmit antennas or transmit antenna paths, for instance, four virtual antennas may be created from two physical antennas by mapping data symbols onto said two physical transmit antennas and additionally onto two virtual antennas that are created based on said two physical antennas, e.g. by mapping said data symbols on two different antenna beams formed by weighting the two physical antennas to obtain said two virtual antennas.

At least four data symbols are modulated onto two orthogonal transmission resources, so that said non-orthogonal matrix modulation has a symbol rate of 2 or higher.

The data symbols that have been mapped to one specific of said at least four transmit antennas are multiplied with the same factor γ in both of said orthogonal transmission resources. If for instance a first data symbol and a rotation of a second data symbol have been assigned to a first antenna and to the first orthogonal transmission resource and the second orthogonal transmission resource, respectively, both the first data symbol and the rotated second data symbol are multiplied with said factor γ.

After said mapping of said data symbols onto said at least four transmit antennas and two orthogonal transmission resources and the multiplication of the data symbols mapped to one specific of said at least four transmit antennas, all the simply mapped data symbols and the mapped and multiplied data symbols are transmitted to said at least one receive antenna in said two orthogonal transmission resources. If said orthogonal transmission resources are data symbol periods, then said mapped data symbols are transmitted from said at least four transmit antennas in two subsequent data symbol periods. Said transmission may comprise further signal processing such as spreading, filtering, and RF-modulation.

Correspondingly, at said receiver, RF-demodulation, filtering and de-spreading may be performed, as well as synchronization and equalization. Furthermore, said mapped and possibly multiplied data symbols may be organized in frames prior to transmission.

Said factor γ may be a complex- or real-valued number. If said mapped and possibly multiplied data symbols are organized frames, said factor γ may be constant for a frame or may change across the frame. Said factor γ may be determined at a transmitter associated with said at least four transmit antennas, at a receiver associated with said at least one receive antenna, or at another instance, and is determined at least in dependence on the transmission channel characteristics from said at least four transmit antennas to the at least one receive antenna. Said transmission channel characteristics may for instance be related to the channel impulse response of the physical propagation channels between each transmit antenna and each receive antenna, wherein said channel impulse response may also incorporate transceiver characteristics. Said transmission channel characteristics may for instance be estimated at said receiver via pilot-symbol based (non-blind) or pilot-symbol free (blind) channel estimation techniques. If said factor γ is determined at said receiver, it may be fed back via a feed-back channel from said receiver to said transmitter. Said factor γ is determined in a way that self-interference between said at least four data symbols is reduced as compared to the case when no multiplication of the symbols mapped to said one transmit antenna was performed.

The present invention achieves a reduction of self-interference between data symbols that are modulated with a symbol-rate-2 (or higher) non-orthogonal matrix modulation scheme and thus increases the performance (for instance, in terms of bit error rate or spectral efficiency) of any communication system that uses said non-orthogonal matrix modulation. This desirable feature is accomplished by properly determining said factor γ and multiplying only the data symbols mapped to one of said at least four transmit antennas with said factor γ. Thus a minimum amount of implementation at the transmitter site is required. Furthermore, if said factor γ is determined at the receiver site and fed back to the transmitter site, the data load of said feed-back overhead only refers to said single factor γ. Thus in contrast to prior art, wherein only the orthogonalization of a symbol-rate-1 non-orthogonal matrix modulation with weight factors applied to all transmit antennas is disclosed, a significant increase in symbol rate and a significant reduction in both transmitter site implementation effort and feed-back data load is achieved.

According to an embodiment of the present invention, said two orthogonal transmission resources are two data symbol periods in the time domain. The non-orthogonal matrix modulation scheme then is a space-time matrix modulation scheme.

According to an embodiment of the present invention, said step of mapping said at least four data symbols onto at least four transmit antennas and two orthogonal transmission resources via said non-orthogonal matrix modulation comprises mapping a first and a second data symbol of said at least four data symbols onto two of said at least four transmit antennas and said two orthogonal transmission resources via an orthogonal matrix modulation, and mapping a third and a fourth data symbol of said at least four data symbols onto two further transmit antennas of said at least four transmit antennas and said two orthogonal transmission resources via an orthogonal matrix modulation.

Said non-orthogonal matrix modulation is then composed of two orthogonal matrix modulations, wherein the first orthogonal matrix modulation maps two data symbols to two transmit antennas and the two orthogonal transmission resources, and the second matrix modulation maps two further data symbols to two further transmit antennas, but onto the same two orthogonal transmission resources. The joint usage of the two orthogonal transmission resources by both orthogonal matrix modulation causes the resulting matrix modulation scheme to become non-orthogonal. Said two orthogonal matrix modulation schemes may be the same or be different.

According to an embodiment of the present invention, said two orthogonal transmission resources are two data symbol periods in the time domain, and wherein said orthogonal matrix modulations are orthogonal space-time block codes. Said orthogonal matrix modulations may for instance be the same and be represented by the STTD block code.

According to an embodiment of the present invention, said self-interference between said at least four data symbols depends on two different values α(γ) and β(γ), and α(γ) and β(γ) depend on said transmission channel characteristics from said at least four transmit antennas to said at least one receive antenna and on said factor γ. Said self-interference is represented by the non-zero elements on the off-diagonal of the matched filter matrix associated with the equivalent channel matrix of said non-orthogonal matrix modulation scheme. All said non-zero elements may then be functions of said values α(γ) and β(γ), for instance rotations thereof. Said values α(γ) and β(γ) depend on said factor γ and on the transmission channel characteristics between said at least four transmit antennas and said at least one receive antenna. Thus by properly determining said factor γ, said non-zero elements α(γ) and β(γ) and thus said self-interference can be reduced.

According to an embodiment of the present invention, each of said at least four transmit antennas is represented by an index i=1, . . . , 4 , wherein hᵢ denotes a transmission channel vector containing the transmission channel coefficients (also denoted as Channel Impulse Response (CIR)) from the transmit antenna represented by index i to said at least one receive antenna, wherein the data symbols that are transmitted from the transmit antenna represented by index i=1 are multiplied with said factor γ, and wherein α(γ)=γ·h₃^{H}·h₁+h₂^{H}·h₄ and β(γ)=γ·h₄^{H}·h₁−h₂^{H}·h₃ hold. Said indices may for instance be randomly assigned to said at least four transmit antennas, or be assigned to said at least four transmit antenna in a certain order. Said transmission channel coefficients contained in said transmission channel vector may be complex-valued numbers that completely define the transmission characteristics (such as attenuation due to path loss, shadowing and fading and phase shift due to propagation delay, Doppler and reflection, refraction and scattering) of the transmission channels between said transmit antenna represented by index i and said at least one receive antenna, respectively, for instance in a frequency-flat fading channel. Therein, the superscript ^{“H”} denotes transposition of a vector and forming the conjugate-complex of all its elements. The data symbols mapped to any one of said at least four transmit antennas may be multiplied with said factor γ, wherein, of course, the choice of the transmit antenna has to be considered when determining said factor γ.

According to an embodiment of the present invention, said factor γ is determined to minimize the function Δ(γ)=|α(γ)|²+|β(γ)|². With self-interference between data symbols being quantified by functions of said values α(γ) and β(γ), respectively, and with both values depending on said factor γ, a separate minimization of said values α(γ) and β(γ) may be sub-optimum, so that it is advantageous to define the function Δ(γ) and minimize this function instead. Recognizing that self-interference in non-orthogonal matrix modulation can be significantly reduced with only one degree of freedom (represented by the factor γ) although it depends on at least two values α(γ) and β(γ) may be considered as one important contribution to the present invention.

According to an embodiment of the present invention, said factor γ stems from a limited set of factors Y , and wherein said factor γ is determined as

$$γ = arg {min}_{\overline{γ} ∈ Y} ( {\vert α ( \overline{γ} ) \vert}^{2} + {\vert β ( \overline{γ} ) \vert}^{2} ) .$$

Constraining said factor γ to a limited set Y of possible factors may reduce the complexity of determining γ, because the target function that is to be minimized may only have to be computed for each possible value of γ from said set Y . Furthermore, if γ is determined at a receiver site and fed back to a transmitter site, a reduction of the feed-back load may be accomplished by properly indexing the factors γ in said set Y.

According to an embodiment of the present invention, said factor γ is a phasor of the form y=e^{jθ}, wherein θ is a phase that stems from a limited set of phases Θ, and wherein said phase θ for said phasor γ is determined as

$$θ = arg {min}_{θ ∈ Θ} ( {\vert α \text{(} {ⅇ}^{j \overline{θ}} \text{)} \vert}^{2} + {\vert β \text{(} {ⅇ}^{j \overline{θ}} \text{)} \vert}^{2} ) .$$

Said factor γ then only performs rotations on the data symbols that are mapped to said transmit antenna at which γ is multiplied, which may further reduce the implementation effort at the receiver site. Said rotation may for instance be integrated in a mixer or a similar modulation or filtering device at said receiver side. To determine said factor γ, it is then only necessary to determine said phase θ.

According to an embodiment of the present invention, said limited set of phases Θ contains M phases that are uniformly placed on the unit circle so that the phase difference between each two adjacent phases is

$$\frac{2 π}{M} .$$

This assignment may further simplify both the determination of the factor γ and the implementation of its multiplication at the transmitter site.

According to an embodiment of the present invention, said at least four transmit antennas are associated with a transmitter, wherein said at least one receive antenna is associated with a receiver, and wherein information related to said factor γ is fed back from said receiver to said transmitter. For instance, said factor γ may be determined at said receiver and fed back to said transmitter, or only the phase θ may be determined at the receiver and fed-back to the transmitter, or only information on γ or θ, such as indices associated with the elements or the respective sets Y and Θ, may be fed back.

According to an embodiment of the present invention, said transmission channel characteristics from said at least four transmit antennas to said at least one receive antenna are determined or estimated at said receiver. This may be accomplished by channel estimation techniques with or without the use of pilot symbols, as is known to a person skilled in the art.

According to an embodiment of the present invention, said at least four transmit antennas are associated with a transmitter, wherein said at least one receive antenna is associated with a receiver, wherein said phase θ for said factor γ=e^{jθ} is determined at said receiver, and wherein a representation of said phase θ is fed back to said transmitter.

According to an embodiment of the present invention, M=2^{K} holds, said set of phases Θ is defined as

$$Θ = \{ \frac{2 π k}{{2}^{K}} , k = 0 , … , {2}^{K} - 1 \} ,$$

each phase in said set of phases Θ is assigned a unique K-element bit string, and said fed back representation of said phase θ is the bit string that is assigned to that phase of said set of phases Θ that equals θ. In a closed-loop system, the amount of feed-back data then can be significantly reduced.

A computer program is further proposed with instructions operable to cause a processor to perform the above-mentioned method steps. Said computer program may for instance be loaded into the internal or external memory of a signal processor of a transmitter or receiver.

A computer program product is further proposed comprising a computer program with instructions operable to cause a processor to perform the above-mentioned method steps. Said computer program product may for instance be stored on any fixed or removable storage medium such as a RAM, a ROM, a cache, a memory card, a disk or a similar medium.

A system is further proposed for reducing self-interference between at least four data symbols that are modulated via a non-orthogonal matrix modulation and transmitted from at least four transmit antennas to at least one receive antenna, said system comprising means arranged for mapping said at least four data symbols onto said at least four transmit antennas and two orthogonal transmission resources via said non-orthogonal matrix modulation, means arranged for multiplying data symbols mapped to one of said at least four transmit antennas with a factor γ, means arranged for transmitting said mapped data symbols and said mapped and multiplied data symbols from said at least four transmit antennas to at least one receive antenna in said two orthogonal transmission resources, and means arranged for determining said factor γ at least in dependence on the transmission channel characteristics from said at least four transmit antennas to said at least one receive antenna to reduce a self-interference between said at least four data symbols. Said system may for instance be a wireless or wire-bound communication system.

According to an embodiment of the present invention, the system further comprises means arranged for receiving and detecting said transmitted mapped data symbols and said mapped and multiplied data symbols from said at least four transmit antennas in said two orthogonal transmission resources.

A transmitter is further proposed for reducing self-interference between at least four data symbols that are modulated via a non-orthogonal matrix modulation and transmitted from at least four transmit antennas of said transmitter to at least one receive antenna of a receiver, said transmitter comprising means arranged for mapping said at least four data symbols onto said at least four transmit antennas and two orthogonal transmission resources via said non-orthogonal matrix modulation, means arranged for multiplying data symbols mapped to one of said at least four transmit antennas with a factor γ, wherein said factor γ is determined at least in dependence on the transmission channel characteristics from said at least four transmit antennas to said at least one receive antenna to reduce a self-interference between said at least four data symbols, and means arranged for transmitting said mapped data symbols and said mapped and multiplied data symbols from said at least four transmit antennas to said at least one receive antenna in said two orthogonal transmission resources. Said transmitter may for instance be deployed in a wireless or wire-bound communication system.

A receiver is further proposed for reducing self-interference between at least four data symbols that are modulated via a non-orthogonal matrix modulation and transmitted from at least four transmit antennas of a transmitter and at least one receive antenna of said receiver, said receiver comprising means for receiving and detecting at least four data symbols that are mapped onto said at least four transmit antennas and two orthogonal transmission resources via said non-orthogonal matrix modulation, and transmitted from said at least four transmit antennas to said at least one receive antenna in said two orthogonal transmission resources, wherein data symbols mapped to one of said at least four transmit antennas are multiplied with a factor γ prior to transmission, and wherein said factor γ is determined at least in dependence on the transmission channel characteristics from said at least four transmit antennas to said at least one receive antenna to reduce a self-interference between said at least four data symbols. Said receiver may for instance be deployed in a wireless or wire-bound communication system.

According to an embodiment of the present invention, said receiver further comprising means arranged for at least partially determining said factor γ, and means arranged for feeding information related to said factor γ back to said transmitter.

A module is further proposed for reducing self-interference between at least four data symbols that are modulated via a non-orthogonal matrix modulation and transmitted from at least four transmit antennas to at least one receive antenna, wherein said at least four data symbols are mapped onto said at least four transmit antennas and two orthogonal transmission resources via said non-orthogonal matrix modulation, and transmitted from said at least four transmit antennas to at least one receive antenna in said two orthogonal transmission resources, and wherein data symbols mapped to one of said at least four transmit antennas are multiplied with a factor γ prior to transmission, said module comprising means arranged for at least partially determining said factor γ at least in dependence on the transmission channel characteristics from said at least four transmit antennas to said at least one receive antenna to reduce a self-interference between said at least four data symbols. Said module may for instance be a removable unit that is used in a transmitter and/or receiver of a wireless or wire-bound communication system.

These and other aspects of the invention will be apparent from and elucidated with reference to the embodiments described hereinafter.

### BRIEF DESCRIPTION OF THE FIGURES

The figures show:

FIG. 1a: a schematic representation of an exemplary open-loop system with non-orthogonal matrix modulation and reduced self-interference according to the present invention;

FIG. 1b: a schematic representation of an exemplary closed-loop system with non-orthogonal matrix modulation and reduced self-interference according to the present invention;

FIG. 2: a flowchart of a method for reducing self-interference in non-orthogonal matrix modulation according to the present invention;

FIG. 3a: the Bit Error Rate (BER) as a function of the Signal-to-Noise Ratio E_{b}/N₀ in dB for different open-loop and closed-loop detection algorithms according to the present invention for non-orthogonal DSTTD matrix modulation with Nₜ=4 transmit and Nᵣ=2 receive antennas and QPSK-modulated data symbols;

FIG. 3b: the Bit Error Rate (BER) as a function of the Signal-to-Noise Ratio E_{b}/N₀ in dB for different open-loop and closed-loop detection algorithms according to the present invention for non-orthogonal DSTTD matrix modulation with Nₜ=4 transmit and Nᵣ=4 receive antennas and QPSK-modulated data symbols;

FIG. 3c: the Bit Error Rate (BER) as a function of the Signal-to-Noise Ratio E_{b}/N₀ in dB for different open-loop and closed-loop detection algorithms according to the present invention for non-orthogonal DSTTD matrix modulation with Nₜ=4 transmit and Nᵣ=2 receive antennas and QAM-modulated data symbols; and

FIG. 3d: the Bit Error Rate (BER) as a function of the Signal-to-Noise Ratio E_{b}/N₀ in dB for different open-loop and closed-loop detection algorithms according to the present invention for non-orthogonal DSTTD matrix modulation with Nₜ=4 transmit and Nᵣ=4 receive antennas and QAM-modulated data symbols.

### DETAILED DESCRIPTION OF THE INVENTION

The present invention proposes to reduce the self-interference encountered in non-orthogonal matrix modulation with at least four transmit antennas and symbol rates equal to or larger than 2 symbols/time period by multiplying the data symbols mapped to one of said at least four transmit antennas by a factor γ that is properly determined to achieve this self-interference reduction. In the following, for illustrative purposes, the presentation will concentrate on closed-loop space-time matrix modulation. It should however be noted that the present invention lends itself for deployment in the context of all other orthogonal transmission resources such as frequency, polarization, codes or eigenmodes of a channel, and may equally well be applied in open-loop systems in which the factor γ is determined at the transmitter site.

As an example for the application of the present invention, the non-orthogonal DSTTD block code as defined in equation (9) will be considered. The equivalent channel matrix of DSTTD, assuming the application of the factor γ at transmit antenna 1 (other choices of antenna assignments are also possible) is given as:

$$\begin{matrix}{G}_{DSTTD} = [ \begin{matrix}{G}_{1} \\ {G}_{2} \\ ⋮ \\ {G}_{{N}_{r}}\end{matrix} ] \\ with & ( 10 ) \\ {G}_{i} = [ \begin{matrix}γ \cdot {h}_{i 1} & {h}_{i 2} & {h}_{i 3} & {h}_{i 4} \\ {h}_{i 2}^{*} & - γ \cdot {h}_{i 1}^{*} & {h}_{i 4}^{*} & - {h}_{i 3}^{*}\end{matrix} ] , & ( 11 )\end{matrix}$$

and the matched filter matrix follows as

$$\begin{matrix}{R}_{DSTTD} = [ \begin{matrix}{p}_{1} ( γ ) & 0 & {α}^{*} ( γ ) & {β}^{*} ( γ ) \\ 0 & {p}_{1} ( γ ) & - β ( γ ) & α ( γ ) \\ α ( γ ) & - {β}^{*} ( γ ) & {p}_{2} ( γ ) & 0 \\ β ( γ ) & {α}^{*} ( γ ) & 0 & {p}_{2} ( γ )\end{matrix} ] . & ( 12 ) \\ with & \\ {p}_{1} ( γ ) = {\vert γ \cdot {h}_{1} \vert}^{2} + {\vert {h}_{2} \vert}^{2} & ( 13 ) \\ {p}_{2} ( γ ) = {\vert {h}_{3} \vert}^{2} + {\vert {h}_{4} \vert}^{2} & \\ α ( γ ) = γ \cdot {h}_{3}^{*} {h}_{1} + {h}_{2}^{*} {h}_{4} & \\ β ( γ ) = γ \cdot {h}_{4}^{*} {h}_{1} - {h}_{2}^{*} {h}_{3} , & \end{matrix}$$

wherein the hᵢ denotes the transmission channel vectors that contain the transmission channel coefficients from transmit antenna i to all of said at least one receive antennas.

The inventor has proven that a separate minimization of the self-interference terms in R_{DSTTD} independently has no solution under the constraint that only rotations of symbols (multiplications with phasors) can be applied on all or a subset of the transmit antennas. The use of phasors instead of complex-valued weights is particularly advantageous with respect to the fact that phases require much less feed-back information than entire complex-valued weights.

The present invention thus proposes that the optimization criterion consists of minimizing jointly |α(γ)|² and |β(γ)|², with a phasor γ=e^{jθ}. As these squared amplitudes affect equally the non-diagonal (off-diagonal) part of the matched filter matrix R_{DSTTD}, their relative importance is also equal. That suggests finally a fair adaptive criterion for the closed-loop mode of DSTTD with phase feedback: minimize
det(B)=|α(γ)|²+|β(γ)|²
where B refers to the 2×2 matrix □ visible in top right and low left corners of the matched filter matrix R_{DSTTD} (see equation (12)).

Intuitively, one might expect that the more phasors are applied on the transmit antennas, the better the optimization performance will be. But this intuitive idea shall not be completely relevant in this case. Indeed, using a plurality of different phasors does not render always the optimization better as the modification of a transmission channel coefficient hᵢⱼ with a phasor affects both α(γ) and β(γ) in an independent manner.

Moreover, the practical implementations of the feedback mode related to the feedback word length restricts the maximum number of phases fed back to the transmitter site.

According to the present invention, therefore a single phasor is applied on one of the available transmit antennas, and the minimization procedure is performed with respect to a single parameter, i.e. the phase θ of the phasor γ=e^{jθ}.

In a closed-loop system, the receiver then estimates the transmission channel coefficients hᵢⱼ and computes the optimal phase θ to be transmitted (for instance via a dedicated feedback channel) as the solution to

$$θ = arg {min}_{θ ∈ Θ} ( {\vert α ( {ⅇ}^{j \overline{θ}} ) \vert}^{2} + {\vert β ( {ⅇ}^{j \overline{θ}} ) \vert}^{2} )$$

where Θ stands for a set of discrete phases

$$Θ = \{ \begin{matrix}\frac{2 π k}{{2}^{K}} , & k = 0 , … , {2}^{K} - 1\end{matrix} \}$$

collecting 2^{K} phases uniformly distributed on [0;2π[. Each of said 2^{K} phases can be encoded onto K bits. Once the optimal phase θ has been determined, its corresponding bit string is obtained for example via a Gray labeling of the set Θ when K=2 or K=3 and constitutes the unique feedback word to be transmitted to the transmitter site. Note that in contrast to the prior art orthogonalization procedure that uses several weights, no information related to the transmit element on which the phasor has to be applied is required. At the transmitter site, then the phasor γ=e^{jθ} is easily constructed and applied to the symbols mapped to the selected transmit antenna 1.

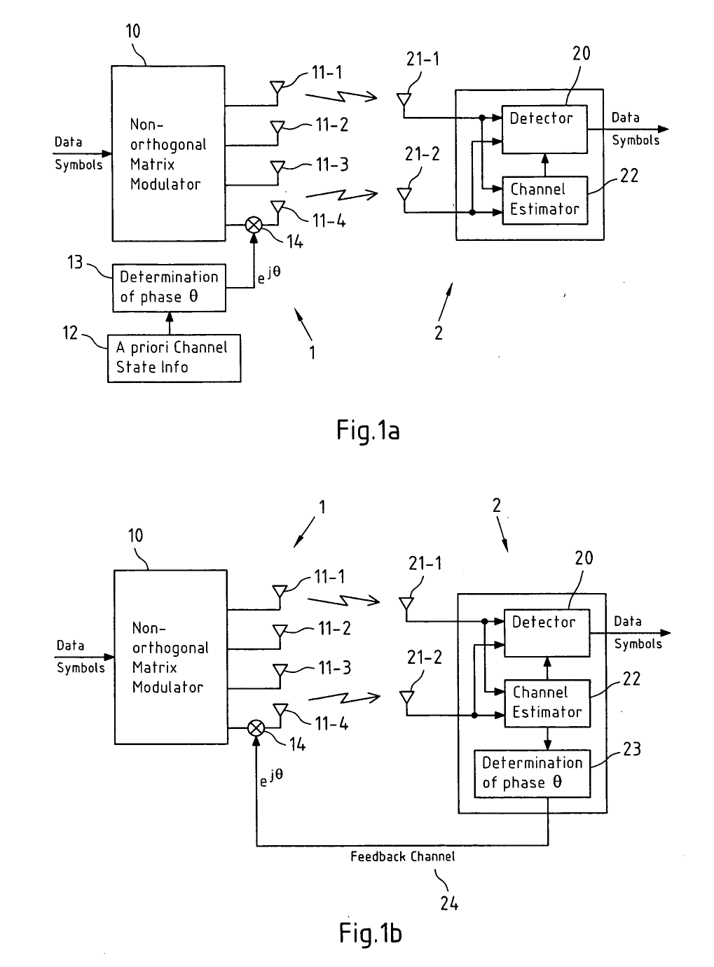

FIGS. 1a and 1b schematically depict the components of a system with non-orthogonal matrix modulation and reduced self-interference according to the present invention, wherein FIG. 1a refers to the open-loop case, and FIG. 1b refers to the closed-loop case. In both cases, the system consists of a transmitter 1 and a receiver 2. Only base-band processing is considered here. It is understood that further processing such as pulse shaping, filtering and RF modulation is required to actually transmit and receive the data symbols at RF frequencies.

In FIG. 1a, data symbols are subject to matrix modulation in the non-orthogonal matrix modulation instance 10 at transmitter 1. Said data symbols are mapped onto four transmit antennas 11-1 . . . 11-4 and two orthogonal transmission resources, for instance two data symbol periods (time slots). Based on channel state information that is stored in an a priori channel state information instance 12, a phase determination instance 13 determines a phase θ of a phasor γ=e^{jθ}, possibly from a limited set of phases, that minimizes the self-interference between said data symbols caused by the lack of orthogonality of the matrix modulation scheme. Said phasor is multiplied by the two data symbols that are mapped to transmit antenna 11-4 in said two orthogonal transmission resources (data symbol periods) by means of a multiplier 14. These mapped and multiplied data symbols and the data symbols mapped to transmit antennas 11-1 . . . 11-3 are transmitted via the MIMO channel to two receive antennas 21-1 and 21-2 of a receiver 2. Said signals received at said receive antennas 21-1 and 21-2 are fed into a channel estimation instance 22, which determines the transmission channel coefficients from each transmit antenna element 11-1 . . . 11-4 to each receive antenna element 21-1 . . . 21-2 and provides said estimates to a detector instance 20. Said detector instance recovers said data symbols from the signals received at receive antenna elements 21-1 and 21-2. In the simplest case, only matched filtering based on the estimated transmission channel coefficients is performed in said detector instance, but equally well, linear equalization techniques such a zero-forcing detection, minimum-means square error detection or their iterative application may be performed. It is also possible that the detector instance implements a Maximum Likelihood detector. The system in FIG. 1a is an open-loop system that relies on the large channel coherence times of the MIMO channel, so that it is possible to use information from the a priori channel state information instance 12 for the determination of said phase θ. However, if the MIMO channel is rapidly changing due to mobility of the transmitter, receiver or of objects in the MIMO channel, the performance of said open-loop system may significantly degrade.

FIG. 1b thus schematically depicts the components of a closed-loop system with non-orthogonal matrix modulation and reduced self-interference according to the present invention, wherein like elements are denoted with the same numerals as in FIG. 1a. As can be readily seen, the a priori channel state information instance 12 and the phase determination instance 13 are no longer required at transmitter 1. Instead, receiver 2 comprises a phase determination instance 23, and a (logical) feed-back channel 24 is established between transmitter 1 and receiver 2 so that the phase θ as determined by instance 23 based on the estimated transmission channel coefficients can be made available to the multiplier 14. Said phase θ preferably stems from a limited set of phases Θ and is represented by a bit-string of K bits, so that only these K bits need to be transmitted over said feed-back channel 24 to said transmitter 1. At said transmitter, the phase θ corresponding to said bit-string is then used to construct said phasor γ=e^{jθ}, and said phasor is then multiplied with the data symbols mapped to antenna 11-4 by multiplier 14. The closed-loop system thus allows for increased flexibility of the system with regards to fluctuations in the MIMO channel and thus increases the performance of the communication system it is deployed in, for instance with respect to BER or spectral efficiency. With the phase θ stemming from said limited set of phases Θ, only a small amount of feed-back is required to signal θ to the transmitter 1.

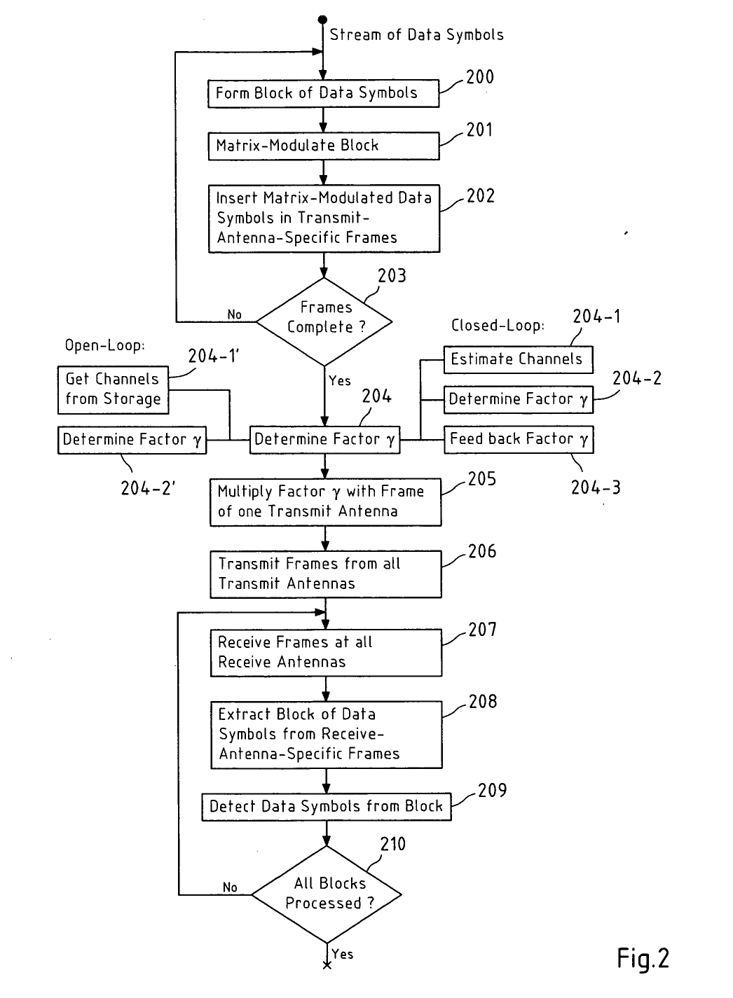

FIG. 2 depicts a flowchart of a method for reducing self-interference in non-orthogonal matrix modulation according to the present invention. It is assumed that a stream of data symbols is transmitted from a transmitter 1 to a receiver 2.

First, in a step 200, the stream of data symbols is segmented into blocks of N=4 data symbols. In a step 201, these N=4 data symbols are matrix-modulated onto four transmit antennas and two orthogonal transmission resources, in the present example T=2 time slots. After said matrix modulation, data symbols are thus assigned for transmission from the four transmit antennas in two symbol periods. The data symbols for these two symbol periods are then inserted into transmit-antenna-specific frames in a step 202, so that after each matrix modulation of a block of N=4 data symbols, in each of the four transmit-antenna-specific frames, two new mapped data symbols, corresponding to said two data symbol periods, are inserted. In a step 203, it is then checked whether the frames have been completely filled up with mapped data symbols. If this is not the case, step 200 is repeated and a new block of data symbols is formed, matrix modulated and the mapped symbols inserted into the four frames, until the frames are filled up.

If the frames are completely filled up, a factor γ is determined. This may either be performed in an open-loop operation, as indicated by steps 204-1′, wherein channels are fetched from a channel storage that is provided at the transmitter, and 204-2′, wherein said factor γ is determined based on said channels. Alternatively, this determination may be performed in closed-loop mode, as indicated by step 204-1 . . . 204-3. In a step 204-1, channels are estimated at a receiver, for instance from pilot symbols inserted into the transmitted frames. Based on these channels, said factor γ is determined in a step 204-2 in a way that the self-interference of the non-orthogonal matrix modulation is reduced. Finally, in a step 204-3, said factor γ or information related to said factor is fed back to the transmitter.

In a step 205, then the factor γ is multiplied with the frame of one transmit antenna, and then this frame and the other three frames are transmitted from the four transmit antenna elements in a step 206. In step 207, the frames that propagated through the MIMO channel and are superposed at each receive antenna element are received as receive-antenna-specific frames. Said step may further comprise both time and frequency synchronization. From said receive-antenna-specific frames, then blocks of T=2 superposed and propagated data symbols are extracted, and based on these blocks, the data symbols of the original stream of data symbols are detected in a step 209, for instance via matched filtering, linear equalization or maximum likelihood detection. The steps 208 and 209 are repeated until all blocks in the receive-antenna-specific frames are processed, i.e. until all data symbols of the original stream of data symbols have been detected. This is controlled by step 210.

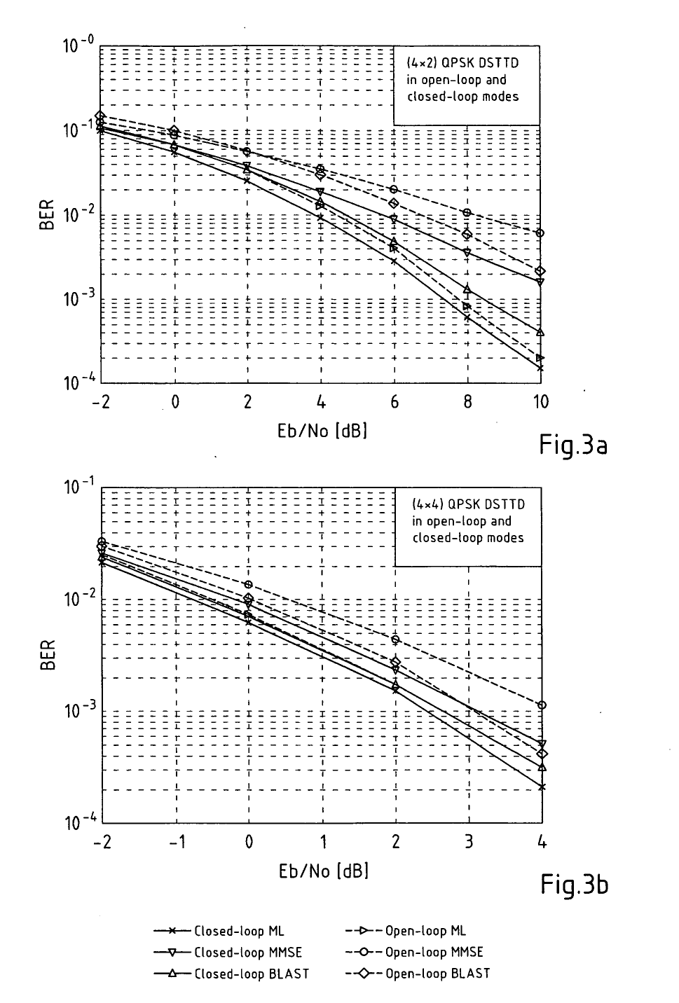

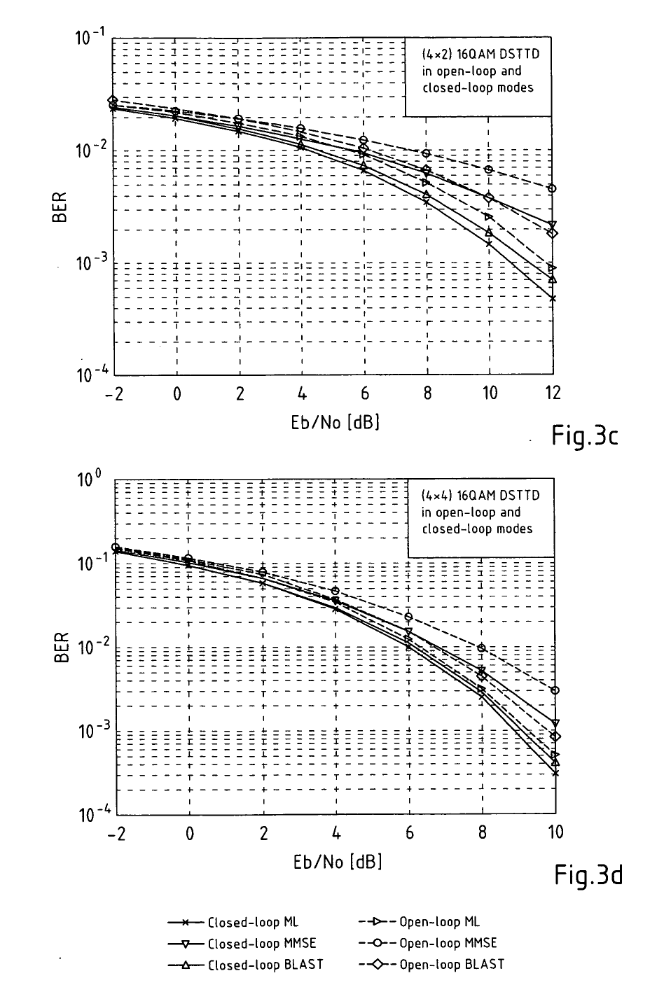

The reduction of self-interference of non-orthogonal matrix modulation schemes according to the present invention has been simulated in a flat fading environment for the exemplary case of DSTTD. FIGS. 3a-3d illustrate the performance of this non-orthogonal matrix modulation scheme with K=3 bits phase feedback, i.e. when the phase θ is selected from a set Θ of size 16. Note that increasing the number of feedback bits does not improve noticeably the transceiver performance so we choose to keep the signaling overhead low by setting the number of feedback bits to a small value K=3. In the plots of FIGS. 3a-3d, the solid lines correspond to the DSTTD closed-loop mode with different receiver algorithms according to the Maximum Likelihood (ML), Minimum Mean Square Error (MMSE) and Bell Labs Layered Space-Time Architecture (BLAST) criterion, while the dashed lines refer to DSTTD open-loop mode (without applying a factor γ).

FIGS. 3a and 3b show the performance at a spectral efficiency of 4 bps/Hz. With Nᵣ=2 receive antennas (FIG. 3a), the Signal-to-Noise Ratio (SNR) E_{b}/N₀ gain at Bit Error Rate (BER) 10⁻² is 2.2 dB with MMSE detection, 2 dB with a BLAST detector but hardly achieves 0.5 dB with ML detection. Suboptimal receiver algorithms such as MMSE and BLAST benefit thus much more from the closed-loop than DSTTD with optimum ML detection. This confirms the intuition that the increase of the diagonal dominance of the matched-filter matrix R_{DSTTD} reduces the noise coloration induced by linear detection.

When the number of receive antennas is set to Nᵣ=4, as depicted in FIG. 3b, the overall performance gain brought by the additional two receive elements can be clearly seen, but on the other hand, the gain brought by the closed-loop mode is reduced in comparison with the 4×2 MIMO case. At BER=2·10⁻³, the difference ranges from 1 dB with MMSE to 0.5 dB with BLAST detection.

Note that the advantage of the closed-loop mode with ML decoding is negligible but one can see that the closed-loop BLAST curve matches the open-loop ML curve, so BLAST detection seems to be the optimal mode in that configuration.

In FIGS. 3c and 3d, the performance of DSTTD at a spectral efficiency of 8 bps/Hz is investigated. Note that with the high rate induced by the use of a 16 QAM modulation instead of QPSK, the requirements for a future 4G system are approached. Observations on the two plots lead to the same general tendency: non-optimal detectors take a greater advantage of the closed-loop mode than the ML detector. When Nᵣ=2 receive antennas are used (FIG. 3c), the performance gain at BER=5·10⁻² varies from 1 dB (ML detector) to 2.5 dB (MMSE detector) while BLAST detection benefits from a 1.2 dB SNR improvement.

Otherwise, the BER curves corresponding to BLAST and ML detection in closed-loop mode remain tightly related in every SNR regime so that the performance penalty caused by BLAST detection compared to ML detection vanishes almost completely in the closed-loop mode.

In FIG. 3d, the results of DSTTD with Nᵣ=4 receive antennas are presented. The results shown on the right plot still exhibit a gain brought by the feedback mode but the gap remains significant only with MMSE (1 dB at BER=10⁻²) and BLAST detection (0.8 dB at BER=10⁻²). Again, the BER curves obtained with ML and BLAST detection are similar.

The invention has been described above by means of some embodiments. It should be noted that there are alternative ways and variations which are obvious to a skilled person in the art and can be implemented without deviating from the scope and spirit of the appended claims. In particular, the present invention is not limited to closed-loop systems or system with non-orthogonal matrix modulation in the space-time domain, equally well open-loop systems and systems operating in the space-frequency, space-code, space-polarization or space-eigenmode domain can benefit from the present invention. Furthermore, the present invention is not restricted to application in wireless systems, it may equally well be applied in wire-bound systems. The at least four transmit antennas required for the non-orthogonal matrix modulation may also be understood as virtual antennas, so that the present invention may also be deployed to system with a smaller number of physical antennas. Equally well, said at least four transmit antennas may represent groups of antennas.

What is claimed is:

1. A method for reducing self-interference between at least four data symbols that are modulated via a non-orthogonal matrix modulation and transmitted from at least four transmit antennas to at least one receive antenna, said method comprising:
mapping said at least four data symbols onto said at least four transmit antennas and two orthogonal transmission resources via said non-orthogonal matrix modulation,
multiplying data symbols mapped to one of said at least four transmit antennas with a factor γ, wherein said factor γ is determined at least in dependence on the transmission channel characteristics from said at least four transmit antennas to said at least one receive antenna to reduce a self-interference between said at least four data symbols, and
transmitting said mapped data symbols and said mapped and multiplied data symbols from said at least four transmit antennas to at least one receive antenna in said two orthogonal transmission resources.

2. The method according to claim 1, wherein said two orthogonal transmission resources are two data symbol periods in the time domain.

3. The method according to claim 1, wherein said step of mapping said at least four data symbols onto at least four transmit antennas and two orthogonal transmission resources via said non-orthogonal matrix modulation comprises:
mapping a first and a second data symbol of said at least four data symbols onto two of said at least four transmit antennas and said two orthogonal transmission resources via an orthogonal matrix modulation; and
mapping a third and a fourth data symbol of said at least four data symbols onto two further transmit antennas of said at least four transmit antennas and said two orthogonal transmission resources via an orthogonal matrix modulation.

4. The method according to claim 3, wherein said two orthogonal transmission resources are two data symbol periods in the time domain, and wherein said orthogonal matrix modulations are orthogonal space-time block codes.

5. The method according to claim 1, wherein said self-interference between said at least four data symbols depends on two different values α(γ) and β(γ), and wherein α(γ) and α(γ) depend on said transmission channel characteristics from said at least four transmit antennas to said at least one receive antenna and on said factor γ.

6. The method according to claim 1, wherein each of said at least four transmit antennas is represented by an index i=1, . . . , 4, wherein hᵢ denotes a transmission channel vector containing the transmission channel coefficients from the transmit antenna represented by index i to said at least one receive antenna, wherein the data symbols that are transmitted from the transmit antenna represented by index i=1 are multiplied with said factor γ, and wherein α(γ)=γ·h₃^{H}·h₁+h₂^{H}·h₄ and β(γ)=γ·h₄^{H}·h₁−h₂^{H}·h₃.

7. The method according to claim 6, wherein said factor γ is determined to minimise the function Δ(γ)=|α(γ)|²+|β(γ)|².

8. The method according to claim 6, wherein said factor γ stems from a limited set of factors Y , and wherein said factor γ is determined as
$$γ = arg {min}_{\overline{γ} ∈ Y} ( {\vert α ( \overline{γ} ) \vert}^{2} + {\vert β ( \overline{γ} ) \vert}^{2} ) .$$

9. The method according to claim 8, wherein said factor γ is a phasor of the form y=e^{jθ}, wherein θ is a phase that stems from a limited set of phases Θ, and wherein said phase θ for said phasor γ is determined as
$$θ = arg {min}_{θ ∈ Θ} ( {\vert α ( {ⅇ}^{j \overline{θ}} ) \vert}^{2} + {\vert β ( {ⅇ}^{j \overline{θ}} ) \vert}^{2} ) .$$

10. The method according to claim 9, wherein said limited set of phases Θ contains M phases that are uniformly placed on the unit circle so that the phase difference between each two adjacent phases is
$$\frac{2 π}{M} .$$

11. The method according to claim 1, wherein said at least four transmit antennas are associated with a transmitter, wherein said at least one receive antenna is associated with a receiver, and wherein information related to said factor γ is fed back from said receiver to said transmitter.

12. The method according to claim 11, wherein said transmission channel characteristics from said at least four transmit antennas to said at least one receive antenna are determined or estimated at said receiver.

13. The method according to claim 10, wherein said at least four transmit antennas are associated with a transmitter, wherein said at least one receive antenna is associated with a receiver, wherein said phase θ for said factor γ=e^{jθ} is determined at said receiver, and wherein a representation of said phase θ is fed back to said transmitter.

14. The method according to claim 13, wherein M=2^{K} holds, wherein said set of phases Θ is defined as
$$Θ = \{ \begin{matrix}\frac{2 π k}{{2}^{K}} , & k = 0 , … , {2}^{K} - 1\end{matrix} \} ,$$
wherein each phase in said set of phases Θ is assigned a unique K-element bit string, and wherein said fed back representation of said phase θ is the bit string that is assigned to that phase of said set of phases Θ that equals θ.

15. A computer program with instructions operable to cause a processor to perform the method steps of claim 1.

16. A computer program product comprising a computer program with instructions stored in a memory, the instructions operable to cause a processor to perform the method steps of claim 1.

17. A system for reducing self-interference between at least four data symbols that are modulated via a non-orthogonal matrix modulation and transmitted from at least four transmit antennas to at least one receive antenna, said system comprising:
means arranged for mapping said at least four data symbols onto said at least four transmit antennas and two orthogonal transmission resources via said non-orthogonal matrix modulation,
means arranged for multiplying data symbols mapped to one of said at least four transmit antennas with a factor γ,
means arranged for transmitting said mapped data symbols and said mapped and multiplied data symbols from said at least four transmit antennas to at least one receive antenna in said two orthogonal transmission resources, and
means arranged for determining said factor γ at least in dependence on the transmission channel characteristics from said at least four transmit antennas to said at least one receive antenna to reduce a self-interference between said at least four data symbols.

18. The system according to claim 17, said system further comprising:
means arranged for receiving and detecting said transmitted mapped data symbols and said mapped and multiplied data symbols from said at least four transmit antennas in said two orthogonal transmission resources.

19. A transmitter for reducing self-interference between at least four data symbols that are modulated via a non-orthogonal matrix modulation and transmitted from at least four transmit antennas of said transmitter to at least one receive antenna of a receiver, said transmitter comprising:
means arranged for mapping said at least four data symbols onto said at least four transmit antennas and two orthogonal transmission resources via said non-orthogonal matrix modulation,
means arranged for multiplying data symbols mapped to one of said at least four transmit antennas with a factor γ, wherein said factor γ is determined at least in dependence on the transmission channel characteristics from said at least four transmit antennas to said at least one receive antenna to reduce a self-interference between said at least four data symbols, and
means arranged for transmitting said mapped data symbols and said mapped and multiplied data symbols from said at least four transmit antennas to said at least one receive antenna in said two orthogonal transmission resources.

20. A receiver for reducing self-interference between at least four data symbols that are modulated via a non-orthogonal matrix modulation and transmitted from at least four transmit antennas of a transmitter and at least one receive antenna of said receiver, said receiver comprising:
means for receiving and detecting at least four data symbols that are mapped onto said at least four transmit antennas and two orthogonal transmission resources via said non-orthogonal matrix modulation, and transmitted from said at least four transmit antennas to said at least one receive antenna in said two orthogonal transmission resources, wherein data symbols mapped to one of said at least four transmit antennas are multiplied with a factor γ prior to transmission, and wherein said factor γ is determined at least in dependence on the transmission channel characteristics from said at least four transmit antennas to said at least one receive antenna to reduce a self-interference between said at least four data symbols.

21. The receiver according to claim 20, further comprising:
means arranged for at least partially determining said factor γ, and
means arranged for feeding information related to said factor γ back to said transmitter.

22. A module for reducing self-interference between at least four data symbols that are modulated via a non-orthogonal matrix modulation and transmitted from at least four transmit antennas to at least one receive antenna, wherein said at least four data symbols are mapped onto said at least four transmit antennas and two orthogonal transmission resources via said non-orthogonal matrix modulation, and transmitted from said at least four transmit antennas to at least one receive antenna in said two orthogonal transmission resources, and wherein data symbols mapped to one of said at least four transmit antennas are multiplied with a factor γ prior to transmission, said module comprising:
means arranged for at least partially determining said factor γ at least in dependence on the transmission channel characteristics from said at least four transmit antennas to said at least one receive antenna to reduce a self-interference between said at least four data symbols.
